(19) United States
(12) Patent Application Publication
(10) Pub. No.: US 2005/0060230 A1
(43) Pub. Date: Mar. 17, 2005

(54) Methods and systems for providing real-time incentive for text submissions

(76) Inventor: Evan John Kaye, New York, NY (US)

Correspondence Address: MORGAN LEWIS & BOCKIUS LLP, 1111 PENNSYLVANIA AVENUE NW, WASHINGTON, DC, 20004, US

(21) Appl. No.: 10/914,703

(22) Filed: Aug. 9, 2004

Related U.S. Application Data
(60) Provisional application No. 60/493,908, filed on Aug. 8, 2003.

(51) Int. Cl. G06F 17/60; G06K 9/34; G06K 9/00; G06F 3/00; G06F 9/00; G06F 17/00

(52) U.S. Cl. 705/14; 705/10; 382/181; 715/780

(57) ABSTRACT

In one aspect of a preferred embodiment, the invention comprises a system for providing an incentive for text entry, comprising: a server computer in communication with an electronic computer network; a database in communication with the server computer; an administrator computer in communication with the server computer; and an accounts payable computer in communication with the server computer; wherein the server computer is operable to transmit a form over the electronic computer network to a user computer; and wherein the form comprises at least one text input area; and at least one reward value display wherein a displayed reward value is related to an amount of text entered into the at least one text input area.

### CROSS-REFERENCE TO RELATED APPLICATIONS

This application claims the benefit of U.S. Provisional Application No. 60/493,908, filed Aug. 8, 2003.

### FIELD OF INVENTION

The present invention relates to methods for providing real-time incentive for participants in electronic surveys, newsgroups, or other activity requiring text submission, to submit comprehensive and generously articulated ideas and passages. More specifically, the present invention provides incentive for respondents to answer open-ended survey questions fully and comprehensively.

### BACKGROUND OF INVENTION

Many surveys and newsgroup discussions are conducted electronically via the web. Depending on who is commissioning the survey, and the population being surveyed, the respondents may or may not receive monetary compensation. In the cases where they do receive monetary compensation it is often a fixed amount regardless of the quality or extent of the respondent's answers.

Questions in surveys take many forms. Some are multiple-choice, others are numeric, and some are open-ended text questions where the respondent may be expected to enter a detailed response comprising a few sentences. For questions with discrete choices (e.g. multiple choice, or yes/no questions) it is simple and a standard practice to enforce, if required, the selection of one (or more in some cases) of the answer choices. When a similar rule is applied to an open ended question requiring a typed response in a text area, the rule is often simply that something need be entered in the text area, but there is no incentive for the respondent to type extensive commentary. There are often no repercussions or penalties for the respondent if they just enter a short or inadequate response. What is needed in the art is a method of providing incentive to survey respondents to fully answer open-ended questions.

The Internet is host to many newsgroup discussions. Many of the discussions are public and open to any participants. People have various motivations for participating in such discussions. There are also private newsgroup discussions, where a sponsor may commission a discussion by qualified people on a topic relating to its product or service, for instance; this is likened to an electronic focus group. While some newsgroup respondents are compensated on a fixed basis (e.g., a set dollar amount per week) for a minimum number of postings, what is needed in the art is a method for providing incentive to newsgroup participants to fully discuss and explore their thoughts on a given subject extensively by linking the amount paid to the volume of text posted.

The Internet also supports real-time chat sessions and instant message sessions. While most of these are elective, what is needed in the art is a method of compensating one or more participants for their submissions to such sessions based on the volume of text contributed to the discussion.

### SUMMARY

A preferred embodiment of the invention provides methods and systems for constructing a units-earned meter to be used to provide incentive to a participant in an electronic survey, newsgroup discussion, or other activity requiring text submission. The units will usually be a currency amount. The accrued units preferably are displayed in real-time as the volume of text typed increases in an adjacent text entry area. The directly-related instantaneous positive feedback during the submission process provides incentive for the respondent to type a full answer to the question (in the case of a survey), or a full response to another posting (in the case of a newsgroup discussion). The amount earned per volume of text is predetermined by the body commissioning the activity. The volume will usually be related to the number of characters (e.g. $0.05 per character). In some cases, the amount that can be earned will be capped, either in total or per response.

In one aspect of a preferred embodiment, the invention comprises software for facilitating a positive feedback incentive for a user to enter text, wherein the interface comprises: a) at least one text input area; and b) at least one reward value display, wherein a displayed reward value is related to an amount of text entered into the at least one text input area. In various embodiments, the displayed reward value is directly correlated with a number of characters in the text input area; the displayed reward value is dynamically updated at each keystroke in the text input area; the displayed reward value is directly correlated with a number of words in the text input area; a plurality of text input areas are provided, and the displayed reward value is directly correlated with an aggregate number of characters in the plurality of text input areas; the displayed reward value is capped in total; and/or the displayed reward value is capped on a per-response basis.

In another aspect, the invention comprises a system for providing an incentive for text entry, comprising: a server computer in communication with an electronic computer network; a database in communication with the server computer; an administrator computer in communication with the server computer; and an accounts payable computer in communication with the server computer; wherein the server computer is operable to transmit a form over the electronic computer network to a user computer; and wherein the form comprises at least one text input area; and at least one reward value display wherein a displayed reward value is related to an amount of text entered into the at least one text input area.

In another aspect, the invention comprises a method for providing a real-time incentive for text entry, comprising the steps of: electronically calculating a first number of characters in a text box located on a computer screen; receiving an electronic signal indicating that a keyboard key has been pressed while a cursor is located in the text box; electronically calculating a second number of characters in the text box; electronically calculating a difference between the first number and the second number; electronically calculating a compensation amount based on at least one of the first and second numbers; and displaying the compensation amount on the computer screen. Various embodiments comprise: (1) a step of checking whether the difference is greater than a pre-determined positive number and, if the difference is greater than the pre-determined positive number, displaying a message on the computer screen warning a user not to paste text into the text box; (2) a step of checking whether the difference is greater than a pre-determined positive number and, if the difference is greater than the pre-determined positive number, causing the text box to revert to its previous state (when it contained only the first number of characters); and/or (3) causing the text box to revert to its previous state (when it contained only the first number of characters). In other embodiments, the compensation amount is calculated by multiplying a text rate times the difference, then adding the product of the text rate and the difference to a previously calculated compensation amount; and/or the compensation amount is calculated by multiplying a text rate times the second number. In a still further embodiment, the contents of the text box are saved to a database. In any of the above embodiments (where applicable), the text rate may be per character and/or per word.

In another aspect, the invention comprises a method for providing a real-time incentive for text entry, comprising the steps of: receiving an electronic signal indicating that a keyboard key has been pressed while a cursor is located in a text box; electronically calculating a number of characters in the text box; electronically calculating a compensation amount based on the number of characters; and displaying the compensation amount on the computer screen. In one embodiment, the compensation amount is calculated by multiplying a text rate times the number of characters. Various embodiments comprise: (1) a step of checking whether the number of characters is greater than a pre-determined positive number and, if the number of characters is greater than the pre-determined positive number, displaying a message on the computer screen warning a user not to paste text into the text box; (2) a step of checking whether the number of characters is greater than a pre-determined positive number and, if the number of characters is greater than the pre-determined positive number, causing the text box to revert to the state immediately before the keyboard key was pressed; and/or (3) causing said text box to revert to the state immediately before said keyboard key was pressed; key was pressed. In a still further embodiment, the contents of the text box are saved to a database. In any of the embodiments, the text rate may be per character and/or per word.

### BRIEF DESCRIPTION OF THE FIGURES

FIG. 1 illustrates a network arrangement of hardware, software, and user components for implementing a method in accordance with a preferred embodiment of the invention;

FIG. 2 illustrates a process flow whereby a survey administrator enters and executes a survey with standard text responses and incentive text responses;

FIG. 3 illustrates a process flow whereby a member in a population participates in a survey that they were invited to, and is paid for such participation;

FIG. 4 shows an exemplary form (registration form) whereby a person registers to become a member of a population.

FIG. 5 shows an exemplary form (survey initiation form) used by an administrator to begin authoring a survey;

FIG. 6 shows an exemplary form (header and sample specification form) used by an administrator to author a survey;

FIG. 7 shows the initial survey draft display before questions are added;

FIG. 8 shows an exemplary form (question construction form) where the question entered is a Standard Text question;

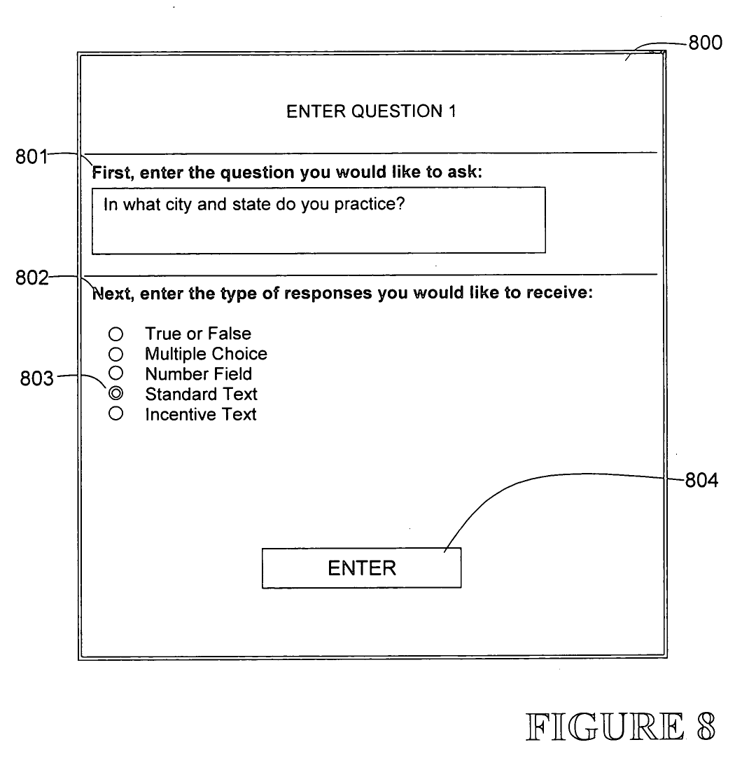

FIG. 9 shows the survey draft display once one Standard Text question has been added to the survey draft;

FIG. 10 shows an exemplary form (question construction form) where the question entered is an Incentive Text question;

FIG. 11 shows the survey draft display once one Standard Text question has been added to the survey draft followed by an Incentive Text question;

FIG. 12 shows an exemplary form (send invitation form) used by the administrator to set the base compensation for a survey and initiate the sending of the email invitations;

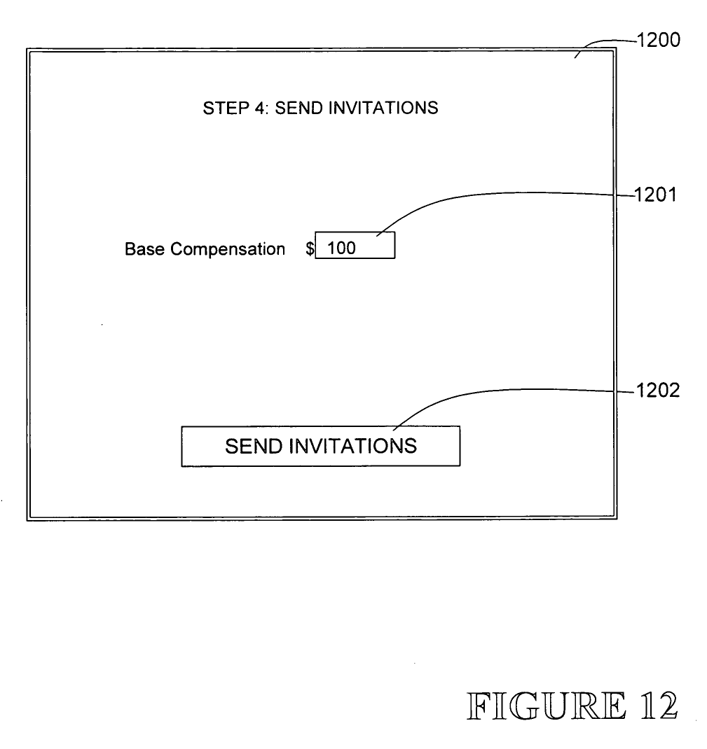

FIG. 13 shows an exemplary email invitation to a prospective survey participant;

FIG. 14 shows an exemplary initial web page (welcome page) viewed by a prospective survey participant when they click through to take the survey;

FIG. 15 shows the live survey form with answers for Standard Text and Incentive Text questions as seen by a survey respondent;

FIG. 16 shows a confirmation page seen by the survey respondent once they complete and submit the survey form;

FIG. 17 shows the survey results as viewed by the survey administrator;

FIG. 18 shows exemplary script in the form of Javascript that is used to update the Incentive Text question's additional compensation amount earned box;

FIG. 19 illustrates a process flow whereby Incentive Text question additional compensation amount is dynamically updated with each keystroke.

### DETAILED DESCRIPTION OF PREFERRED EMBODIMENTS

A preferred embodiment of the invention comprises methods for designing a survey to be filled out electronically that contains one or more incentive text questions, inviting a population sample to fill out a survey for a specified compensation level with the opportunity to earn over and above that amount by means of incentive text questions, generating a survey form with real-time feedback of additional compensation earned, and calculating and processing individualized payments.

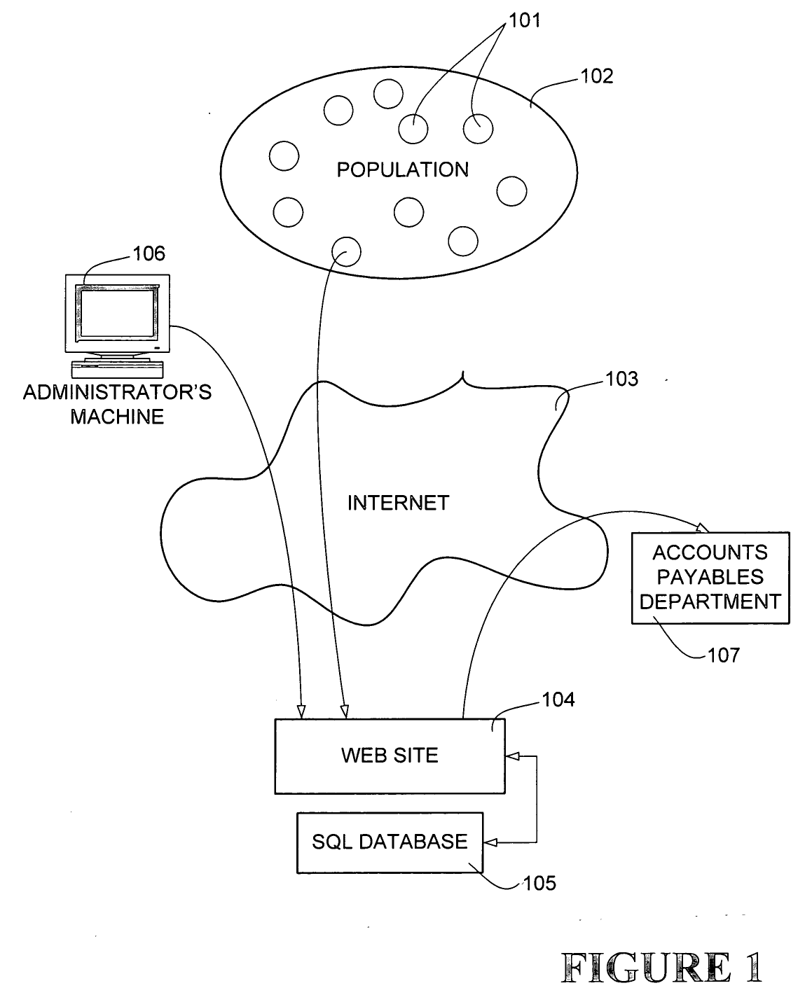

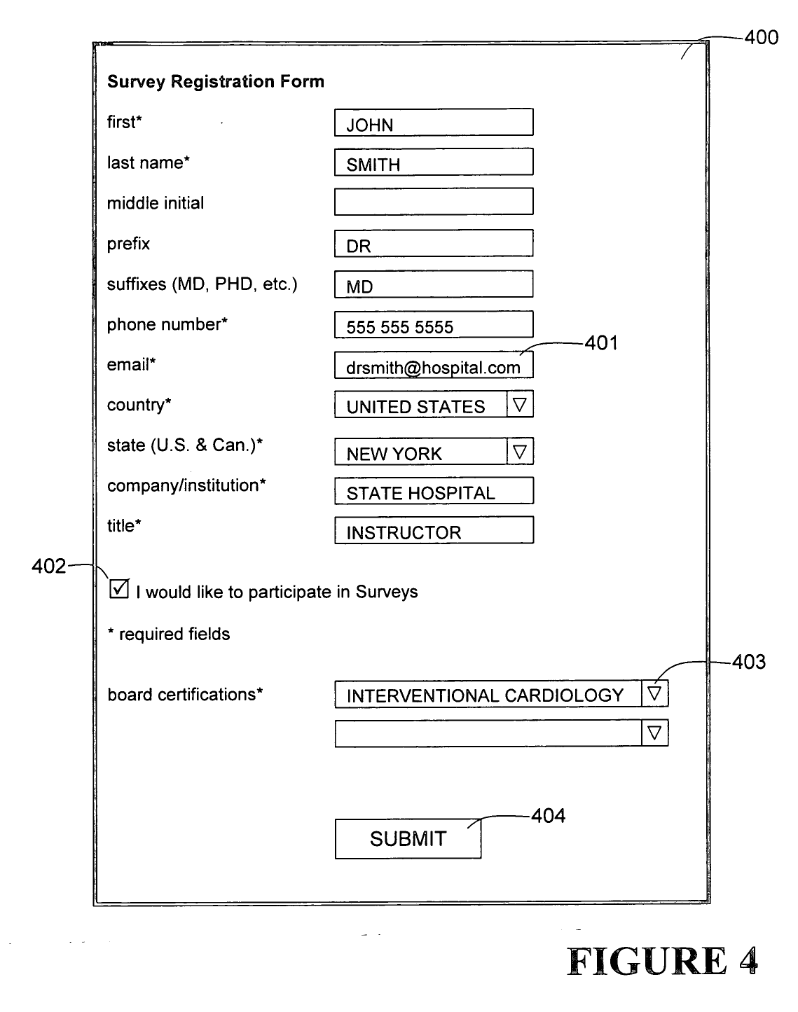

Components of a preferred system embodiment are depicted in FIG. 1. Members 101 of a population 102 may have previously expressed interest in receiving survey invitations by way of email. They may do this by means of a web form 400 (see FIG. 4) on website 104 via the Internet 103 where they indicate their preferred email address 401 and qualifications (certifications 403) for being included in said population 102. Member email addresses 401 and qualifications (certifications 403) are stored in a SQL Database 105.

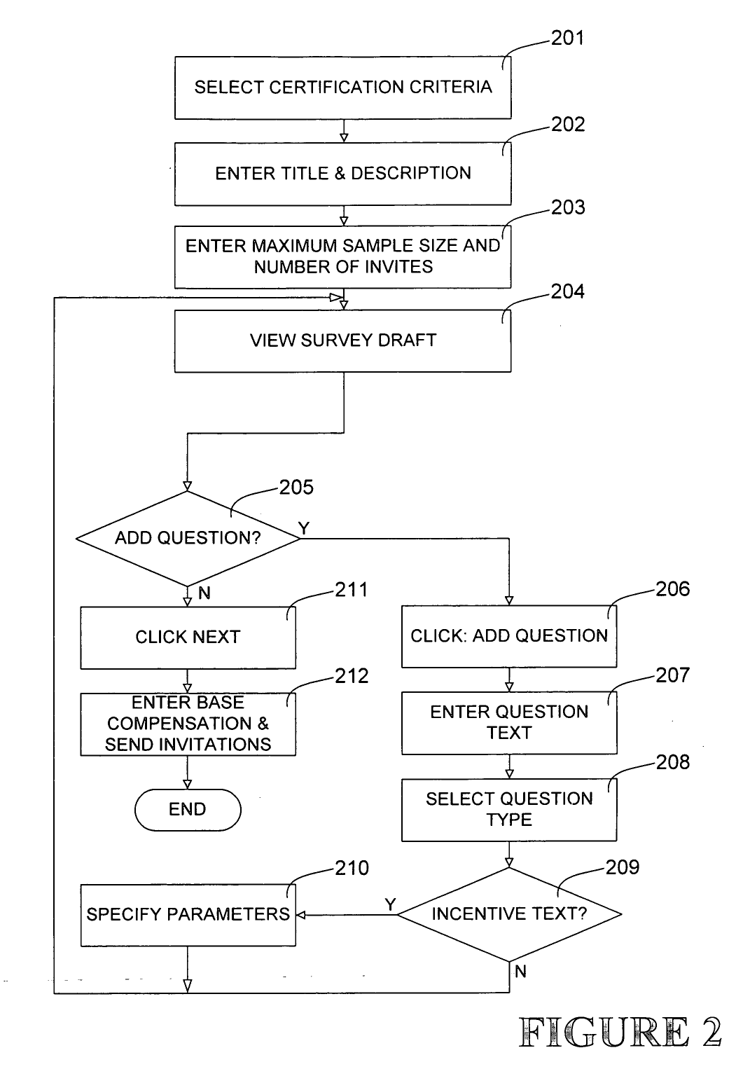

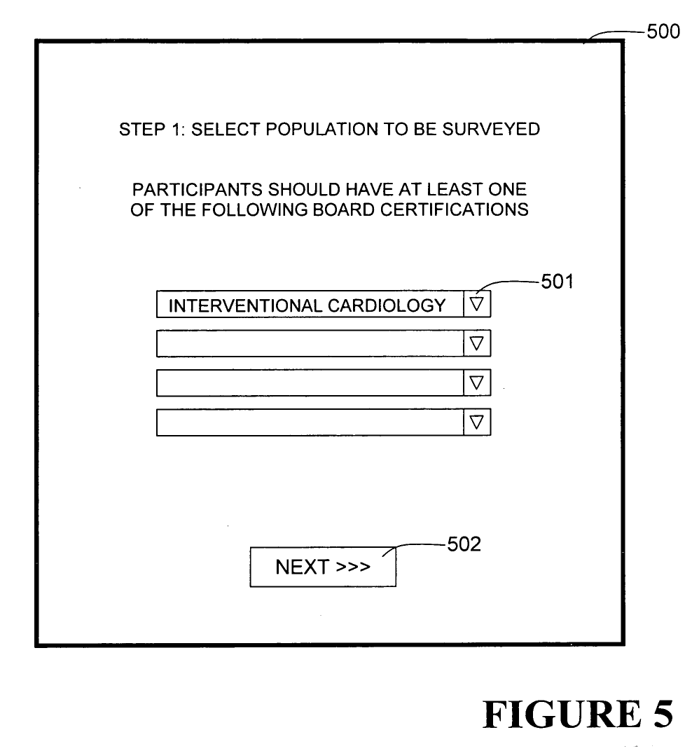

With reference now to the flowchart in FIG. 2, an administrator 106 can, via the Internet 103 and a web form 400 (see FIG. 4) on a website 104, at step 201 initiate the authoring of a survey by indicating the population to be surveyed through the selection of certification criteria 501 (see FIG. 5) from a standard dropdown box on a population selection web form 500. The administrator 106 then continues by clicking the Submit button 502.

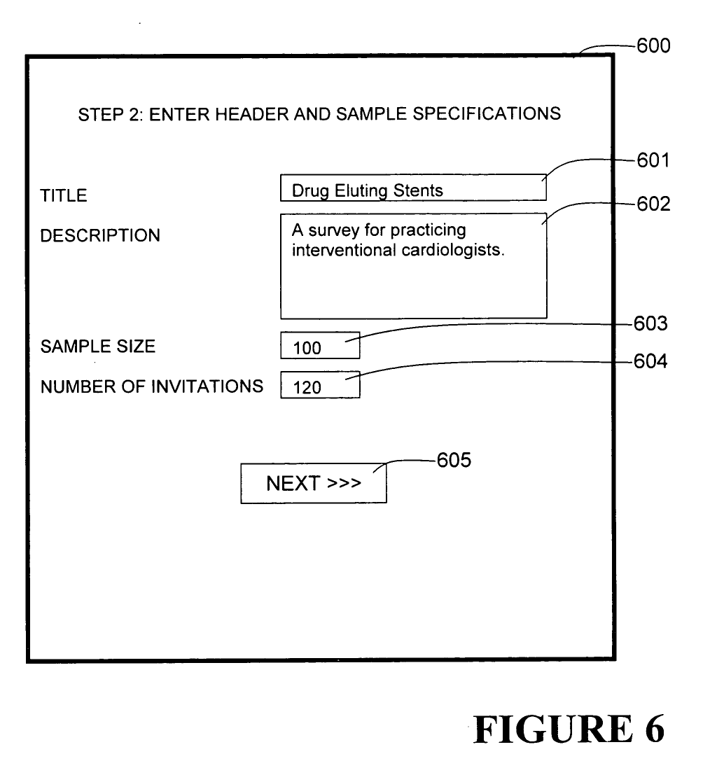

At step 202 the administrator 106 enters, on a web form 600 (see FIG. 6), the Title 601 and Description 602 of the survey. On the same web form at step 203 the administrator enters the Sample Size 603, which will be used to determine whether to allow a respondent to fill out the survey, or refuse their entry if the Sample Size has been attained. Additionally, on the same web form 600 the administrator 106 also enters the number of invitations to be sent 604. The administrator 106 then proceeds by clicking the Next button 605.

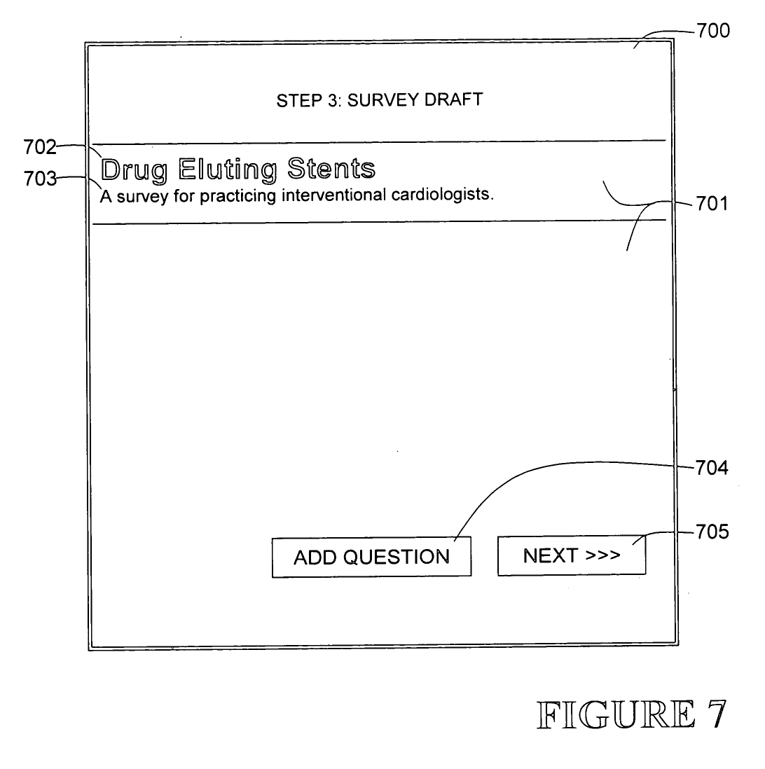

At step 204 the administrator 106 views a web page 700 (see FIG. 7) that displays a survey draft 701 with the entered Title 702 and Description 703, and displays a button, Add Question 704, which the administrator 106 clicks to proceed to step 206 if they wish to add a question at step 205.

At step 207 the administrator 106 views a web form 800 where it is required that the question be entered in area 801, and the type of question be selected in area 802 at step 208. The question type options in area 802 include a Standard Text 803 question type. By way of example the administrator 106 may at step 208 select a Standard Text 803 question type before clicking the Enter button 804 to proceed. In this case at step 209 the question type selected at step 208 was not Incentive Text so the system moves back to step 204.

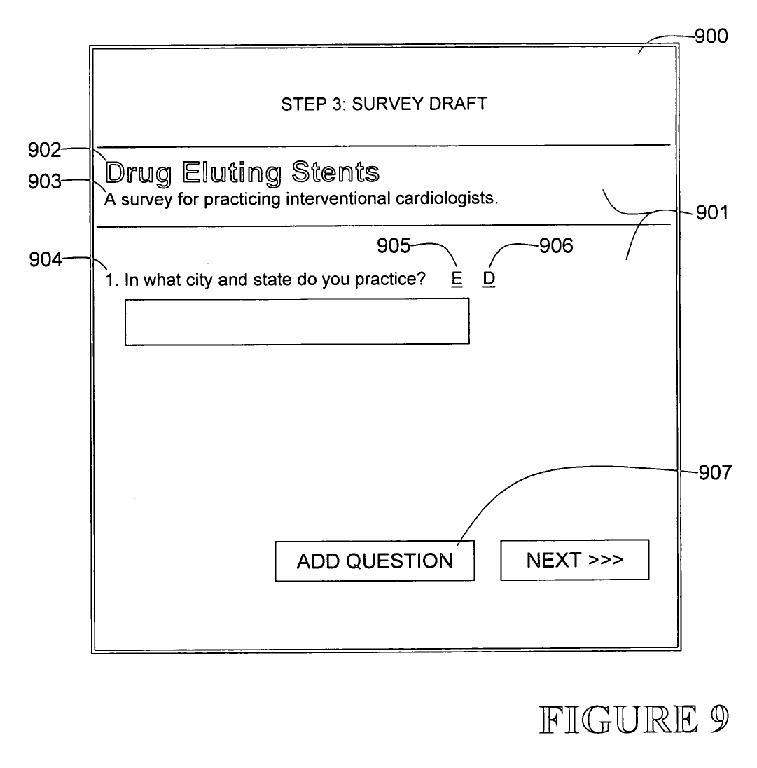

At step 204 the administrator 106 now views a web form 900 (see FIG. 9) similar to web form 700 (see FIG. 7). Only now the first question 904 has been added and is displayed below the Title 902 and Description 903 of the survey. One skilled in the art will appreciate that all questions will be appended to the survey draft 901 and displayed in a similar manner to the way the first question 904 was added. There is also both an Edit link 905 and a Delete link 906 on the web page. By way of example the administrator 106 may now continue at step 205 by deciding to add another question and click Add Question 907 at step 206.

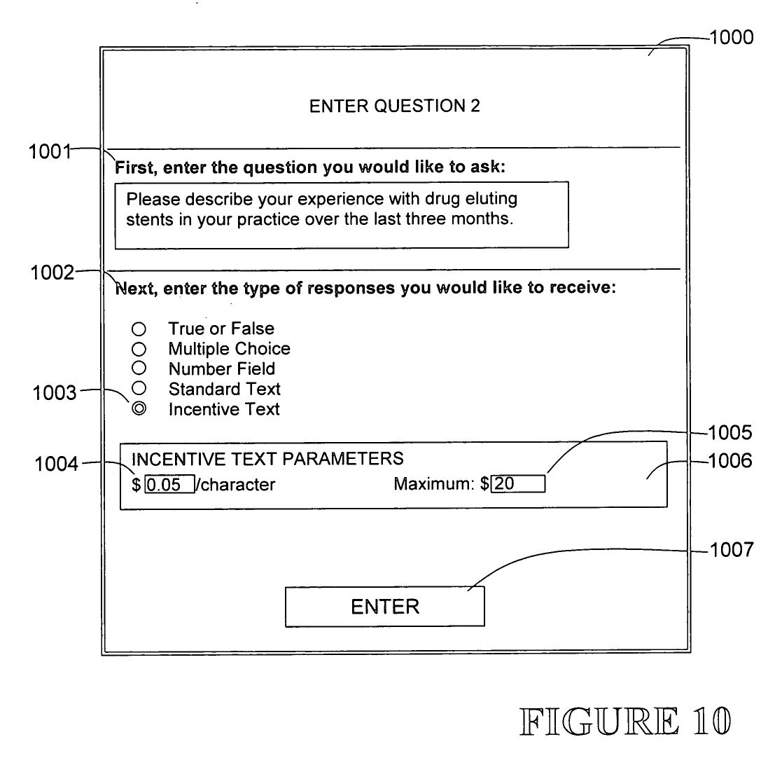

At step 207 the administrator 106 enters the question text on a web form 1000 (see FIG. 10) in space 1001, and then at step 208 may select the question type in area 1002 as Incentive Text 1003. As the Incentive Text 1003 radio-button option is selected, a box 1006 appears on the web page by means of Javascript, DHTML, or other client side script familiar to those skilled in the art. The box 1006 allows the administrator 106 to complete steps 209 and 210. The specification of parameters is done either by accepting or changing the default settings in box 1004 of $0.05 per character typed and $20 in box 1005 as the maximum payout for the answer. The administrator 106 completes step 210 by clicking the Enter button 1007, and returns to step 204.

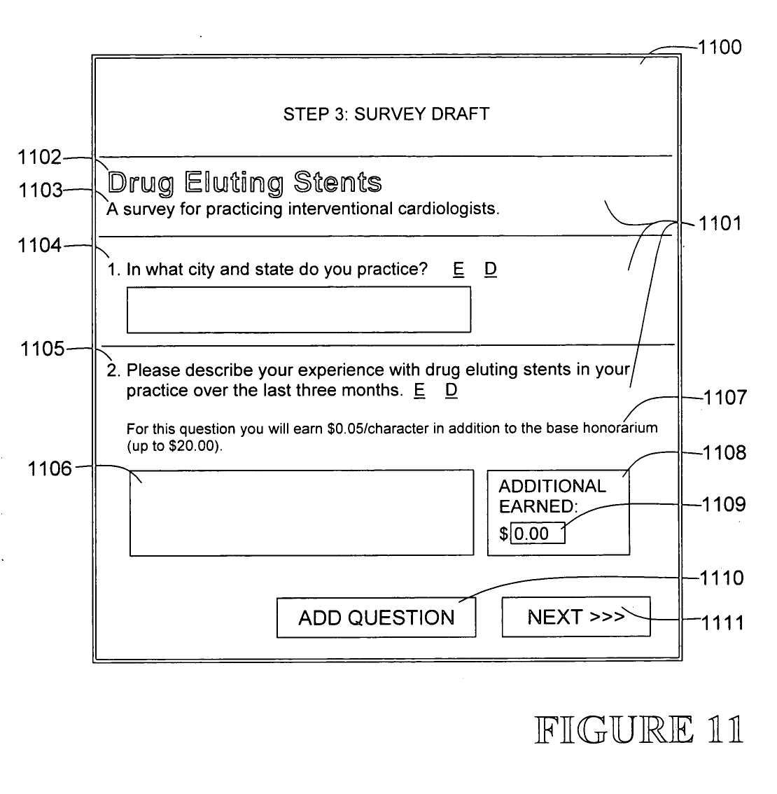

At step 204 the administrator 106 now views a web form 1100 (see FIG. 11) similar to web form 900 (see FIG. 9). Only now the second question 1105 has been added and is displayed in the survey draft 1101 below the Title 1102, Description 1103 and the previously added question 1104. Of note is the Additional Earned notification box 1108 that appears next to the text box 1106 in which the respondent types their response. Said Additional Earned notification box 1108 will, in the currency display box 1109, at the time the survey is run, dynamically display the incremental compensation earned as the respondent types their response. The Incentive Text question 1105 also differs from the Standard Text question 1104 as it contains a notification 1107 that the respondent will earn additional compensation, and the given parameters by which this is earned.

At this time the administrator 106 may terminate the construction of the survey draft at step 205 by electing not to add an additional question with button Add Question 1110, but rather clicking the Next button 1111 at step 211.

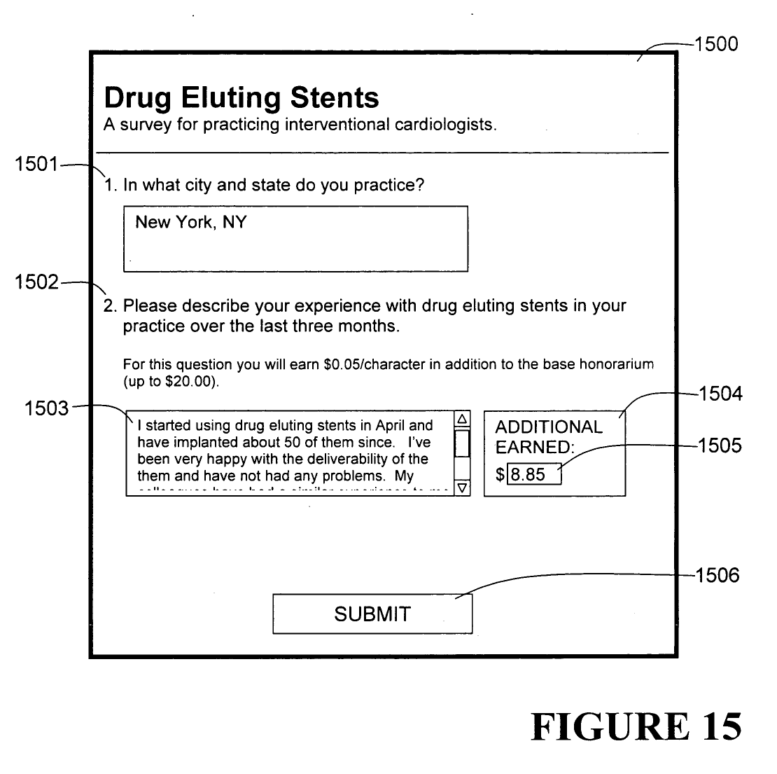

At step 212 the administrator 106 enters the Base Compensation amount for each survey respondent in box 1201. The Base Compensation amount is that amount the survey respondent will be paid if they do not fill in any text in the Incentive Text question answer boxes 1503 (see FIG. 15). The administrator then completes step 212 by clicking the Send Invitations button 1204 which initiates the automated sending of invitation emails to a random selection of members 101 from the selected population 102.

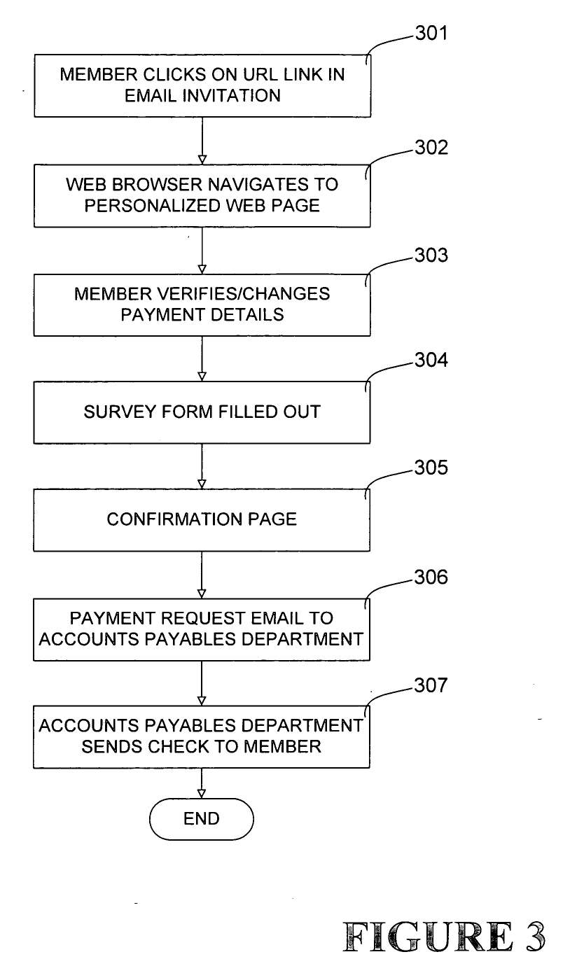

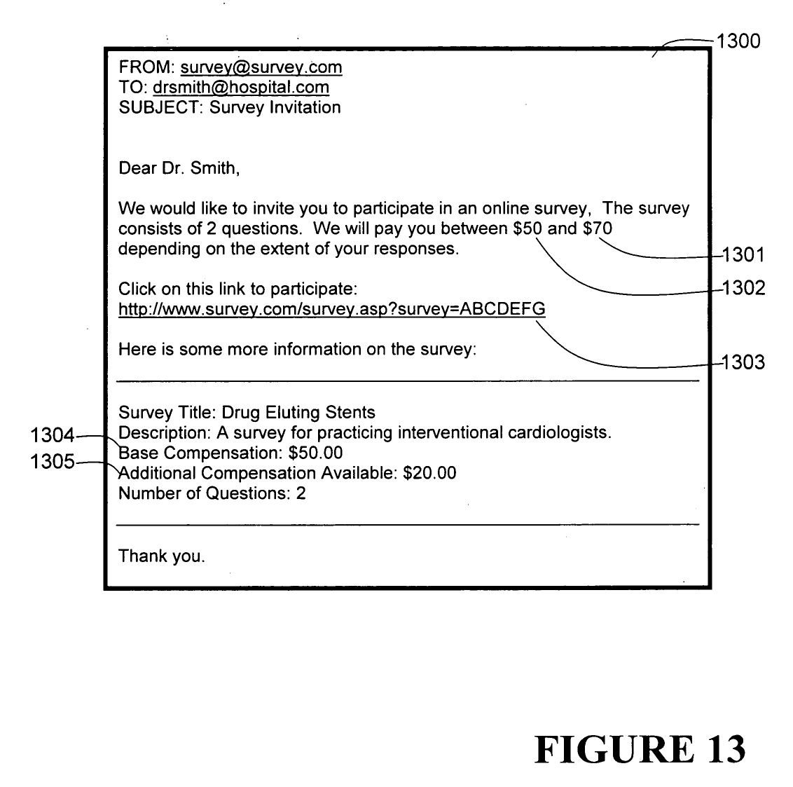

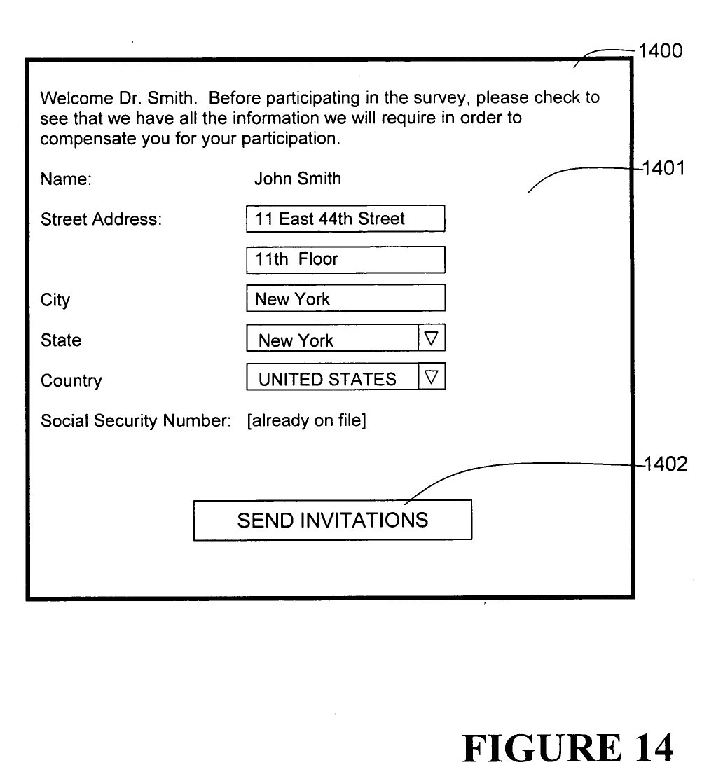

An exemplary email invitation 1300 (see FIG. 13) contains the Base Compensation Amount 1302 and 1304 as well as the summation of the base with the total additional available compensation 1305 across all incentive text questions in the survey 1301. It also contains a unique URL link 1303 that, when clicked by the member 101 at step 301 (see FIG. 3) will cause the web browser to navigate at step 302 to website 104 (see FIG. 1) with the identifying information in the URL link 1303 used to identify the member 101 and the survey to be taken by them. This identifying step is done by checking the SQL Database 105. Such identification allows for the generation of a personalized web page 1400 (see FIG. 14) where the member 101 verifies, and changes if necessary, their payment details 1401 as previously entered on form 400 (see FIG. 4) and recorded on the SQL server 105 (see FIG. 1) and clicks the Submit button 1402 at step 303 to proceed to the survey form 1500 (see FIG. 15).

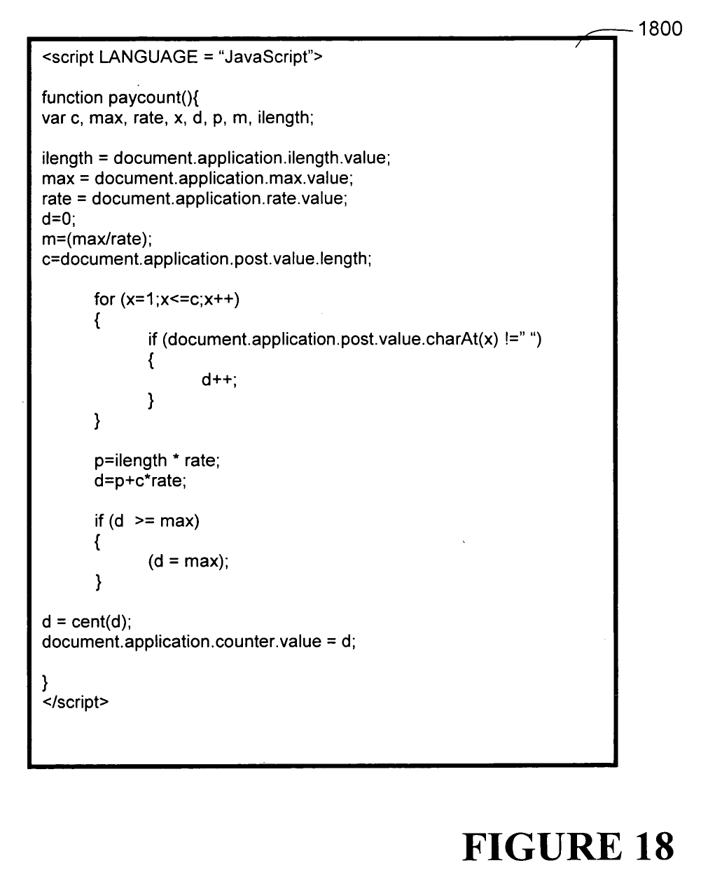

The previously authored survey form 1500 (see FIG. 15) is displayed at step 304. The member 101 may fill the form out sequentially or in random order. When answering an incentive text question 1502, the additional compensation earned 1505 is reflected in a box 1504 adjacent to the text area 1503 in which the response is typed. Typing in the text area 1503 triggers a Javascript procedure that updates the compensation amount 1505 in the adjacent box 1504. With reference now to FIG. 18 exemplary code 1800 for such a procedure is presented. It can be appreciated by those with skill in the art that such code can be modified to be included once in the HTML code for a survey form and be accessed by all the incentive text questions when typing is done in their respective text areas (1503). The algorithm preferably used in such code is outlined below. The member completes step 304 by clicking on the submit button 1506.

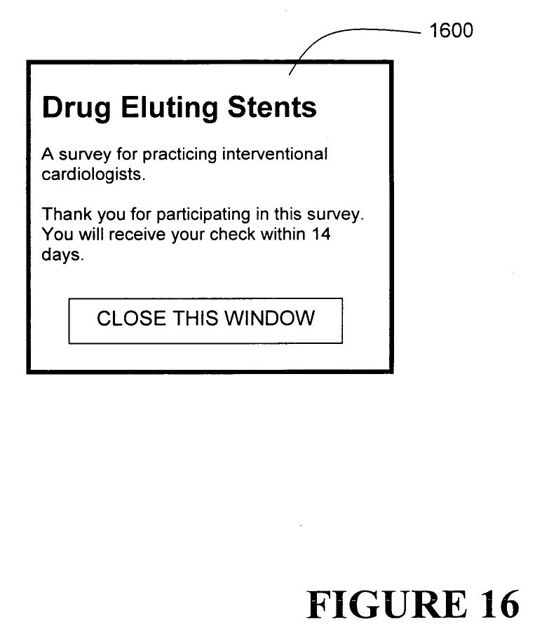

At step 305 a confirmation page 1600 (see FIG. 16) is displayed. At step 306 the ASP code that dynamically generates the web site 103 sends an email to the Accounts Payables department 107 containing the name, address, social security number, and amount to be paid to the member. The amount preferably is recalculated on the ASP server based on the number of characters transmitted in the web form at step 304. The Accounts Payables Department 107 in turn sends a check at step 307 to the member for their services. The value of the check is the aggregate value of the base compensation amount and the additional Incentive Text Question amounts.

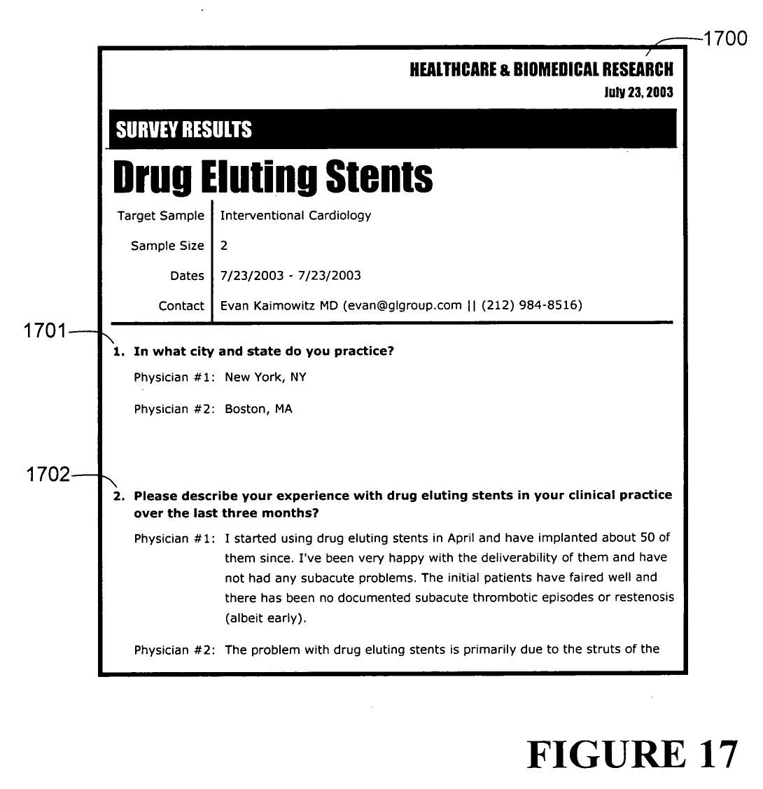

The survey results 1700 (see FIG. 17) show the text responses of both the Standard Text question 1701 and the Incentive Text question 1702. Viewing the results there is no indication that additional compensation was rewarded for the second question 1702.

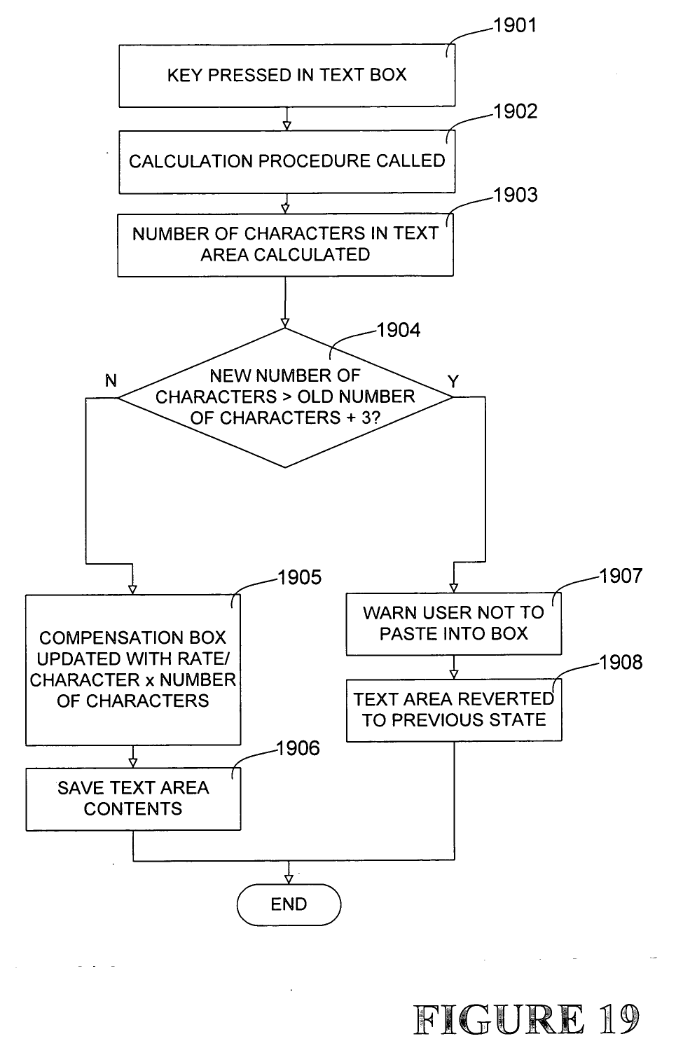

Steps of a preferred algorithm for the real-time calculation of the Incentive Text additional compensation amount and display thereof are outlined in FIG. 19. At step 1901 the user presses a key in the text area of an Incentive Text question, such as area 1503 of Incentive Text question 1502 (see FIG. 15). At step 1902 the calculation procedure is called, such as the procedure shown on in FIG. 18. At step 1903 the number of characters in text area 1502 is calculated. As it is only possible to add one character per keystroke, a test is done at step 1904 to see if more than one character was added since the last keystroke.

If true, then a warning alerts the user not to “paste” text into the box at step 1907. Furthermore, it changes the contents of the text area to the contents in the state before the key was pressed at step 1908.

If false, the compensation box 1505 (see FIG. 15) is updated with the product of the rate/character and the number of characters at step 1905. The rate/character is passed from the server to the web browser of the client. The number of characters is calculated by the Javascript procedure. At step 1906 the contents of the text area are then saved in an additional variable so that, if necessary, said variable may be used to restore the previous state of the text should step 1908 be called for.

Thus, in one embodiment the invention comprises a system for facilitating positive feedback incentive for participants in a dialog, group discussion, or other process requiring text participating to input comprehensive answers or opinions, comprising software for providing: at least one text input area; and at least one reward value display related to the volume of the text entered in said text input area.

In another embodiment, the invention comprises a method to be employed on a server to facilitate a dialog between two users of available instant messaging software, wherein incentive is provided to one or both participants by means of intermittent messages sent to said incentivized users notifying them of their amount earned.

While the methods and systems of the present invention have been described in terms of the above illustrated embodiments, those skilled in the art will recognize that the invention is not limited to the embodiments described. The present invention can be practiced with a variety of modifications and alterations within the spirit and scope of the appended claims.

1. Software for facilitating a positive feedback incentive for a user to enter text, wherein the interface comprises:
a) at least one text input area; and
b) at least one reward value display, wherein a displayed reward value is related to an amount of text entered into said at least one text input area.

2. The software of claim 1, wherein said displayed reward value is directly correlated with a number of characters in said text input area.

3. The software of claim 1, wherein said displayed reward value is dynamically updated at each keystroke in said text input area.

4. The software of claim 1, wherein said displayed reward value is directly correlated with a number of words in said text input area.

5. The software of claim 1, wherein a plurality of text input areas are provided, and said displayed reward value is directly correlated with an aggregate number of characters in said plurality of text input areas.

6. The software of claim 1, wherein said displayed reward value is capped in total.

7. The software of claim 1, wherein said displayed reward value is capped on a per-response basis.

8. A system for providing an incentive for text entry, comprising:
a server computer in communication with an electronic computer network;
a database in communication with said server computer;
an administrator computer in communication with said server computer; and
an accounts payable computer in communication with said server computer;
wherein said server computer is operable to transmit a form over said electronic computer network to a user computer; and
wherein said form comprises at least one text input area; and at least one reward value display wherein a displayed reward value is related to an amount of text entered into said at least one text input area.

9. A method for providing a real-time incentive for text entry, comprising the steps of:
electronically calculating a first number of characters in a text box located on a computer screen;
receiving an electronic signal indicating that a keyboard key has been pressed while a cursor is located in said text box;
electronically calculating a second number of characters in said text box;
electronically calculating a difference between said first number and said second number;
electronically calculating a compensation amount based on at least one of said first and second numbers; and
displaying said compensation amount on said computer screen.

10. A method as in claim 9, further comprising a step of checking whether said difference is greater than a pre-determined positive number and, if said difference is greater than said pre-determined positive number, displaying a message on said computer screen warning a user not to paste text into said text box.

11. A method as in claim 9, further comprising a step of checking whether said difference is greater than a pre-determined positive number and, if said difference is greater than said pre-determined positive number, causing said text box to revert to its previous state (when it contained only said first number of characters).

12. A method as in claim 9, further comprising causing said text box to revert to its previous state (when it contained only said first number of characters).

13. A method as in claim 10, further comprising causing said text box to revert to its previous state (when it contained only said first number of characters).

14. A method as in claim 9, wherein said compensation amount is calculated by multiplying a text rate times said difference, then adding the product of the text rate and the difference to a previously calculated compensation amount.

15. A method as in claim 9, wherein said compensation amount is calculated by multiplying a text rate times said second number.

16. A method as in claim 9, further comprising saving contents of said text box to a database.

17. A method as in claim 14, wherein said text rate is per character.

18. A method as in claim 14, wherein said text rate is per word.

19. A method for providing a real-time incentive for text entry, comprising the steps of:
receiving an electronic signal indicating that a keyboard key has been pressed while a cursor is located in a text box;
electronically calculating a number of characters in said text box;
electronically calculating a compensation amount based on said number of characters; and
displaying said compensation amount on said computer screen.

20. A method as in claim 19, wherein said compensation amount is calculated by multiplying a text rate times said number of characters.

21. A method as in claim 19, further comprising a step of checking whether said number of characters is greater than a pre-determined positive number and, if said number of characters is greater than said pre-determined positive number, displaying a message on said computer screen warning a user not to paste text into said text box.

22. A method as in claim 19, further comprising a step of checking whether said number of characters is greater than a pre-determined positive number and, if said number of characters is greater than said pre-determined positive number, causing said text box to revert to the state immediately before said keyboard key was pressed.

23. A method as in claim 19, further comprising causing said text box to revert to the state immediately before said keyboard key was pressed.

24. A method as in claim 20, further comprising causing said text box to revert to the state immediately before said keyboard key was pressed.

25. A method as in claim 19, further comprising saving contents of said text box to a database.

26. A method as in claim 20, wherein said text rate is per character.

27. A method as in claim 20, wherein said text rate is per word.
